(19) United States
(12) Patent Application Publication
(10) Pub. No.: US 2008/0028985 A1
(43) Pub. Date: Feb. 7, 2008

(54) Water-Dispersed Slurry Coating

(76) Inventors: Yasuhiro Shindo, Kyoto (JP); Takeshi Furuta, Kyoto (JP); Yusuke Yamamoto, Kyoto (JP); Kazuyuki Kuwano, Aichi (JP)

Correspondence Address: EDWARDS ANGELL PALMER & DODGE LLP, P.O. BOX 55874, BOSTON, MA, 02205, US

(21) Appl. No.: 10/582,628

(22) PCT Filed: Dec. 10, 2004
(86) PCT No.: PCT/JP04/18955

§ 371 Date: Apr. 4, 2007

(30) Foreign Application Priority Data
Dec. 12, 2003 (JP) 2003-414369

(51) Int. Cl. C09D 175/04

(52) U.S. Cl. 106/287.23

(57) ABSTRACT

This invention relates to a water-dispersed slurry coating which can provide a film excellent in water resistance and strength.

The water-dispersed slurry coating comprises: (A) a particulate comprising (a1) a resin having an active hydrogen; and (B) a reactive surfactant comprising a hydrophilic moiety and a hydrophobic moiety having an aromatic ring-containing hydrocarbon group having 6 to 100 carbon atoms and having at least one group selected from the group consisting of an isocyanate group, a blocked isocyanate group and an epoxy group in the hydrophilic moiety, and having an oxyethylene group in a content of not less than 20% and not more than 97% by weight; and (a2) a curing agent according to need, in aqueous medium.

### TECHNICAL FIELD

The present invention relates to a slurry coating composition. More specifically, the present invention relates to a slurry coating composition that is excellent in dispersibility of resin in water and that can provide a cured film with excellent strength after baking. The present invention also relates to a slurry coating composition which is excellent in water resistance when formed as a film because resin dispersed therein has larger diameter than in conventional emulsion coating composition and thus amounts used of an emulsifier and a dispersing agent are reduced, and which has good workability because of its low viscosity.

### BACKGROUND ART

As slurry coatings are in the form of a dispersion of fine particles in water, upon using them, surfactants are used to prevent the fine particles from cohering or precipitating and to have them stably dispersed in the water (Japanese Patent Laid-Open No. 2001-220544).

### DISCLOSURE OF THE INVENTION

When the slurry with surfactants are practically used as a coating composition, however, the surfactants remaining after the evaporation of the water medium to dryness can worsen water resistance of a film. The surfactants can also develop a plasticizing effect to worsen strength of the film. Therefore, it is an object of the present invention to provide a water-dispersed slurry coating that is improved in the above-described problems and is excellent in water resistance and strength of a film.

The present inventors have made active investigations to solve the problems and completed the present invention.

That is, the first object of the present invention is a water-dispersed slurry coating, comprising: (A) a particulate comprising (a1) a resin having a group containing an active hydrogen; and (B) a reactive surfactant comprising a hydrophilic moiety and a hydrophobic moiety and having at least one group selected from the group consisting of an isocyanate group, a blocked isocyanate group and an epoxy group in the hydrophilic moiety, in aqueous medium, and a film formed with the coating.

Further, the second object of the present invention is a water-dispersed slurry coating, comprising: (A) a particulate comprising (a1) a resin having a group containing an active hydrogen; (B0) a reactive surfactant comprising a hydrophilic moiety and a hydrophobic moiety and having at least one group selected from the group consisting of an amino group, a hydroxyl group and a carboxyl group in the hydrophilic moiety; and (a2) a curing agent, in aqueous medium, and a film formed with the coating.

### EFFECTS OF THE INVENTION

A water-dispersed slurry coating of the present invention can provide a film excellent in strength and also a cured film having excellent properties such as water resistance.

### BEST MODE FOR CARRYING OUT THE INVENTION

Below, the present invention is described in detail.

In the present invention, the reactive surfactants (B) and (B0) (hereinafter, also referred to as (B) and (B0)) comprise a hydrophilic moiety and a hydrophobic moiety. (B) has at least one group selected from the group consisting of an isocyanate group, a blocked isocyanate group and an epoxy group in the hydrophilic moiety, and (B0) has at least one group selected from the group consisting of an amino group, a hydroxyl group and a carboxyl-group. The hydrophobic moiety preferably has an aromatic ring-containing hydrocarbon group having 6 to 100 carbon atoms. The hydrophilic moiety preferably has an oxyethylene group.

Because a slurry coating of the present invention has at least one group, in (B), selected from the group consisting of an isocyanate group, a blocked isocyanate group and an epoxy group, and in (B0), selected from the group consisting of an amino group, a hydroxyl group and a carboxyl group, in a hydrophilic moiety of a reactive surfactant, the hydrophilic moiety of (B) or (B0) having low compatibility to the resin (a1) containing an active hydrogen group can directly bond to the resin (a1), and thus the compatibility to a film is improved and the firm can be excellent in strength and a cured film can also has excellent properties such as water resistance. In addition, upon storing the coating, the resin is excellent in dispersing stability.

Each hydrophilic moiety of (B) and (B0) preferably has an oxyethylene group. A content of the oxyethylene group, based on the weight of (B) or (B0) respectively, is preferably not less than 20% by weight, more preferably not less than 25% by weight, and particularly preferably not less than 30% by weight; and preferably not more than 97% by weight, more preferably not more than 95% by weight, and particularly preferably not more than 93% by weight. An oxyethylene unit not less than 20% and not more than 97% by weight can provide a slurry coating that is strong in emulsifying power and stable.

Each of (B) and (B0) has an oxyethylene group, based on each hydrophilic moiety, preferably not less than 70% by weight, more preferably not less than 75% by weight, and particularly preferably not less than 80% by weight; and preferably not more than 99% by weight, more preferably not more than 98% by weight, and particularly preferably not more than 97% by weight. An oxyethylene unit not less than 70% by weight and not more than 99% by weight can provide a slurry coating that is strong in emulsifying power and stable.

A weight ratio of a hydrophilic moiety (BH) to a hydrophobic moiety (BL) of each of (B) and (B0), (BL/BH) is preferably in the range of not more than 4.0 to not less than 0.03, more preferably not more than 3.0 to not less than 0.05, particularly preferably not more than 2.3 to not less than 0.07.

Hydrophilic/hydrophobic balance (hereinafter, referred to as HLB) of each of (B) and (B0) is preferably 5 to 20, more preferably 7 to 20, in the view of the power of emulsifying an ethylenic unsaturated monomer and the process of dispersing particulates to form a stable aqueous dispersion or emulsion. The HLB of (B) or (B0) can be adjusted by modulating a type and a content of the hydrophobic group and a type and a content of the hydrophilic group. For example, the HLB can be determined according to the Oda's method described in Takehiko Fujimoto, “Shin Kaimenkasseizai Nyumon (New Introduction of Surfactants)”, Completely Revised Version, Sanyo Chemical Industries, Ltd., 1992, p. 197. In other words, an inorganic (hydrophilic) value and an organic (hydrophobic) value of the (B) or (B0) are obtained from the type and the content of the hydrophobic and hydrophilic groups therein using the reference organic value and the reference inorganic value each estimated on each functional group based on the number of carbon atom(s) (for example, these values are shown in Table 3.3.11 of the above reference), and HLB is calculated according to the following formula:

HLB=10×(Inorganic Value/Organic Value)

The reactive surfactant (B) or (B0) in the present invention has not less than one species of hydrophobic moiety (BL) Examples of the hydrophobic moiety include, in the view of dispersing stability, an aromatic ring-containing hydrocarbon group having 6 to 100 or more, preferably 8 to 80 carbon atoms. Examples of the aromatic ring-containing hydrocarbon group include: (BL1) a hydroxyl group-free residue of phenols and a vinyl monomer adduct thereof; (BL2) a hydroxyl group-free residue of bisphenols (such as bisphenol A, bisphenol S, and bisphenol F) and a vinyl monomer adduct thereof; (BL3) a hydroxyl group-free residue of phenol novolac resins (mono- to octa-hydric hydroxyl group) and cresol novolac resins (mono- to octa-hydric hydroxyl group) and a vinyl monomer adduct thereof; and (BL4) a hydroxyl group-free residue of aromatic alcohol.

Specific examples are: (BL1) phenyl group, alkyl(C₁ to C₁₈)phenyl group (such as nonylphenol, dodecylphenol and octylphenol), styrenated (mono- to deca-styrenated) phenyl group, arylalkylphenol (suchascumylphenol), styrenated (mono- to deca-styrenated) cumenyl(isopropylphenyl)group and the like; (BL2) bisphenyl group (such as bisphenol A, bisphenol S and bisphenol F), styrenated (mono- to deca-styrenated) bisphenyl group and the like; (BL3) hydroxyl group-free residue of phenol novolac resin (mono- to octa-hydric hydroxyl group), hydroxyl group-free residue of styrenated (mono- to deca-styrenated) phenol novolac resin (mono- to octa-hydric hydroxyl group), hydroxyl group-free residue of cresol novolac resin mono- to octa-hydric hydroxyl group), hydroxyl group-free residue of styrenated (mono- to deca-styrenated) cresol novolac resin (mono- to octa-hydric hydroxyl group) and the like; and (BL4) hydroxyl group-free residue of benzyl alcohol and the like. Among them, preferable are styrenated (mono- to deca-styrenated) phenyl group and styrenated (mono- to deca-styrenated) cumenyl group.

The reactive surfactant (B) or (B0) in the present invention has not less than one species of hydrophilic moiety (BH).

Examples of the hydrophilic moiety (BH) include the following groups (BH1) and (BH2) that bind to a phenolic or an alcoholic hydroxyl group of the hydrophobic moiety (BL). (BH1): in (B), a group of polyoxyalkylene ether having an isocyanate group, a blocked isocyanate group or an epoxy group in the terminal end thereof and one hydrogen removed therefrom; (BH2): in (B), a group of urethane resin consisting of polyoxyalkylene ether and diisocyanate and having at least one group selected from the group consisting of an isocyanate group, a blocked isocyanate group and an epoxy group in the terminal end thereof and one hydrogen removed therefrom; and in (B0), a group of urethane resin consisting of polyoxyalkylene ether and diisocyanate and having at least one group selected from the group consisting of an amino group, a hydroxyl group and a carboxyl group in the terminal end thereof and one hydrogen removed therefrom.

Any method for introducing isocyanate group or blocked isocyanate group to be contained in a hydrophilic moiety of (B) can be used without limitation, including, for example, a method of reacting one end of organic polyisocyanate with an active hydrogen in a hydrophilic moiety and blocking the remaining NCO group according to need.

Examples of the organic diisocyanate include, but not limited to:

(1) aliphatic diisocyanate having 2 to 18 carbon atoms (wherein the carbon atom in the NCO group is not counted, hereinafter in the same manner) [e.g. ethylene diisocyanate, tetramethylene diisocyanate, hexamethylene diisocyanate (HDI), dodecamethylene diisocyanate, 2,2,4-trimethylhexamethylene diisocyanate, lysine diisocyanate, 2,6-diisocyanatomethyl caproate, bis(2-isocyanatoethyl)fumarate, bis(2-isocyanatoethyl)carbonate and 2-isocyanatoethyl-2,6-diisocyanatohexanoate];

(2) alicyclic diisocyanate having 4 to 15 carbon atoms [e.g. isophorone diisocyanate (IPDI), dicyclohexylmethane-4,4′-diisocyanate (hydrogenated MDI), cyclohexylene diisocyanate, methylcyclohexylene diisocyanate (hydrogenated TDI) and bis (2-isocyanatoethyl)-4-cyclohexene];

(3) aromatic diisocyanate having 6 to 14 carbon atoms [e.g. 1,3- or 1,4-phenylene diisocyanate, 2,4- or 2,6-tolylene diisocyanate (TDI), crude TDI, 2,4′- or 4,4′-diphenylmethane diisocyanate (MDI), 4,4′-diisocyanatobiphenyl, 3,3′-dimethyl-4,4′-diisocyanatobiphenyl, 3,3′-dimethyl-4,4′-diisocyanatodiphenylmethane, crude MDI and 1,5-naphthylene diisocyanate];

(4) aromatic aliphatic diisocyanate having 8 to 15 carbon atoms [e.g. m- or p-xylylene diisocyanate (XDI) and α,α,α′,α′-tetramethylxylylene diisocyanate (TMXDI)];

(5) modification of these diisocyanates [e.g. those having a carbodiimide group, an urethodione group, an urethoimine group or an urea group]; and

(6) mixture of two or more of (1) to (5)

(7) modification of the above-described organic diisocyanates(such as urethane group-, carbodiimide group-, allophanate group-, urea group-, biuret group-, isocyanurate group- or oxazolidone group-containing modification); HDI isocyanurate; HDI biuret; IPDI isocyanurate; IPDI biuret; crude MDI [phosgenated compound of crude diaminodiphenylmethane (such as a condensation product of formaldehyde and an aromatic amine (such as aniline) or a mixture thereof, and a mixture of diaminodiphenylmethane and a small amount (for example, 5 to 20% by weight) of tri- or more-functional polyamine); polyallylpolyisocyanate (PAPI)], and blocked isocyanate compound thereof.

Among them, preferred are HDI, TDI, and IPDI.

Examples of the blocking agent for the isocyanate group include: lactams such as ε-caprolactam, δ-valerolactam and γ-butyrolactam; phenols such as phenol, cresol, ethylphenol, butylphenol, nonylphenol and dinonylphenol; oximes such as methyl ethyl ketone oxime, acetophenone oxime and benzophenone oxime; alcohols such as methanol, ethanol, butanol and cyclohexanol; diketones such as dimethyl malonate, diethyl malonate, methyl acetoacetate, ethyl acetoacetate and acetylacetone; mercaptans such as butyl mercaptan and dodecyl mercaptan; urethodiones such as isophorone diisocyanate dimer and hexamethylene diisocyanate dimer; amides such as acetanilide and acetic acid amide; imides such as succinic acid imide and maleic acid imide; sulfites such as sodium bisulfite; and mixture of two or more of them.

Among them, preferred are alcohols, lactams, oximes and phenols, and particularly preferred are methanol, ethanol and methyl ethyl ketone oxime.

Any method for introducing an epoxy group to be contained in the hydrophilic moiety of (B) can be used without limitation, including, for example, a method of reacting one end of a polyepoxy compound with an active hydrogen in the hydrophilic moiety to introduce the epoxy group.

Examples of the polyepoxy compound include, but not limited to:

glycidyl ester of aromatic polycarboxylic acid such as phthalic acid diglycidyl ester, isophthalic acid diglycidyl ester, terephthalic acid diglycidyl ester and trimellitic acid diglycidyl ester; glycidyl ether of polyhydric phenol such as bisphenol F diglycidyl ether, bisphenol A diglycidyl ether, bisphenol B diglycidyl ether, bisphenol AD diglycidyl ether, bisphenol S diglycidyl ether, halogenatedbisphenol A diglycidyl ether, tetrachlorobisphenol A diglycidyl ether, catechin diglycidyl ether, resorcinol diglycidyl ether, hydroquinone diglycidyl ether, pyrogallol triglycidyl ether, 1,5-dihydroxynaphthalene diglycidyl ether, dihydroxybiphenyl diglycidyl ether, octachloro-4,4′-dihydroxybiphenyl diglycidyl ether, polyglycidyl ether of phenol or cresol novolac resin, diglycidyl ether obtained by a reaction of 2 moles of bisphenol A with 3 moles of epichlorohydrin, polyphenol polyglycidyl ether obtained by a condensation reaction of phenol with glyoxal, glutaraldehyde or formaldehyde and polyphenol polyglycidyl ether obtained by a condensation reaction of resorcin and acetone; glycidyl aromatic polyamine such as N,N-diglycidyl aniline and N,N,N′,N′-tetraglycidyl diphenylmethanediamine; alicyclic polyepoxy compound such as vinylcyclohexene dioxide, limonene dioxide, dicyclopentadiene dioxide, bis(2,3-epoxycyclopentyl)ether, ethylene glycol bisepoxydicyclopentyl ether,
3,4-epoxy-6-methylcyclohexylmethyl-3′,4′-epoxy-6′-methylcyc lohexane carboxylate,
bis(3,4-epoxy-6-methylcyclohexylmethyl) adipate and
bis(3,4-epoxy-6-methylcyclohexylmethyl)butylamine.

### Preferred are bisphenol F diglycidyl ether and bisphenol A diglycidyl ether.

Any method for introducing the hydroxyl group, amino group or carboxyl group to be contained in the hydrophilic moiety of (B0) can be used without limitation, including, for example, a method of synthesizing urethane resin comprising polyoxyalkylene ether having a hydroxyl group or amino group on one terminal end and diisocyanate, and introducing a carboxyl group according to need.

The reactive surfactant (B) of the present invention is preferably urethane resin (B1) having at least one group selected from the group consisting of an isocyanate group, a blocked isocyanate group and an epoxy group. The urethane resin (B1) is preferably urethane resin comprising: (b3) an addition reaction product of (b1) a monohydric phenol or a monohydric aromatic alcohol and (b2) a vinyl monomer according to need, or an alkylene oxide adduct of the addition reaction product; (b4) an organic diisocyanate; (b5) a diol and/or a diamine having a polyoxyalkylene chain; and (b6) a blocking agent or (b7) a polyepoxy compound, as main components, in which said (b3) and/or said (b5) contains an oxyethylene group, and said (b3) and/or said (b5) is added with at least one group selected from the group consisting of a blocked isocyanate group, an epoxy group, a hydroxyl group, and an amino group. Said resin (B1) may optionally comprise (b8) a chain-lengthening agent.

The weight average molecular weight (hereinafter abbreviated as “MW”) of polyoxyethylene chain in the reactive surfactant (B) and (B0) (polyoxyethylene chain of the above (b3) or (b5), or the following (b3′), or the following (b3″) or (B5′)) is, in the view of a water resistance, preferably 1,000 to 4,000, more preferably 1,500 to 3,800, particularly preferably 2,000 to 3,500.

The MW of polyoxyethylene chain of the surfactant (B) and (B0) can be calculated by determining the MW of polyoxyethylene chain of each with hydroxyl number or GPC, and calculating a weight geometric average based on a weight used thereof.

Urethane resin (B1) comprises one or more of compounds represented by the general formulae (1) or (2);

Q—(—CONH—G—NHCO—J—)ₘ—CONH—G—NHCO—Y (1)

Q—(—CONH—G—NHCO—J—)ₘ—Z (2)

Wherein, Q represents a residue of (b3) an addition reaction product of (b1) a monohydric phenol or a monohydric aromatic alcohol and (b2) a vinyl monomer if necessary, or an alkylene oxide adduct of the addition reaction product; G represents a residue of (b4) an organic diisocyanate; J represents a residue of (b5) a diol and/or a diamine having a polyoxyalkylene chain; Y represents a residue of (b6) a blocking agent; and Z represents a residue of (b7) a polyepoxy compound. A plurality of G and a plurality of J may be same or different each other, respectively, m is preferably 1 to 20, more preferably 1 to 10.

The MW of said resin (B1) is preferably 1,000 to 150,000, more preferably 1,500 to 30,000, even more preferably 2,000 to 20,000, particularly preferably 3,000 to 15,000. The MW is, in the way that a sufficient surface activity can be provided, preferably not less than 1,000, more preferably not less than 1,500; and in the way that the resulting aqueous resin dispersion can be low in viscosity and stable, preferably not more than 150,000, more preferably not more than 30,000. The MW can be measured by gel permeation chromatography (GPC).

Any of said (b1) can be used without limitation to form the surfactant (B), including, for example, phenol; alkyl (C₁ to C₁₈) phenol such as nonylphenol, dodecylphenol and octylphenol; arylalkyl phenol such as cumylphenol; monoalkyl (C₁ to C₁₈) ether of bisphenol such asmonomethyl ether of bisphenol A, monobutyl ether of bisphenol A and monobutyl ether of bisphenol S; aromatic alcohol such as benzyl alcohol; and mixture of two or more thereof.

Among them, preferred are phenol and cumylphenol.

As the vinyl monomer (b2), exemplified is a vinyl monomer without an isocyanate group, and for example, an aliphatic vinyl hydrocarbon, an alicyclic vinyl hydrocarbon and an aromatic vinyl hydrocarbon may be used.

Examples of the aliphatic vinyl hydrocarbon include ethylene, propylene, butene, isobutylene, pentene, heptene, diisobutylene, octene, dodecene, octadecene, butadiene, isoprene, 1,4-pentadiene, 1,6-hexadiene, 1,7-octadiene and other α-olefin. Examples of the alicyclic vinyl hydrocarbon include cyclohexene, (di)cyclopentadiene, pinene, limonene, indene, vinylcyclohexene and ethylidene bicycloheptene. Examples of the aromatic vinyl hydrocarbon include styrene, α-methylstyrene, vinyltoluene, 2,4-dimethylstyrene, ethylstyrene, isopropylstyrene, butylstyrene, phenylstyrene, cyclohexylstyrene, benzylstyrene, crotylbenzene, vinylnaphthalene, divinylbenzene, divinyltoluene, divinylxylene, divinylketone and trivinylbenzene.

Among them, preferred is styrene.

The above (b3) is an addition reaction product of (b1) the monohydric phenol or monohydric aromatic alcohol and (b2) the vinyl monomer according to need, or an alkylene oxide adduct thereof. Any alkylene oxide (hereinafter abbreviated as “AO”, having 1 to 30 carbon atoms) can be used without limitation, including, for example, ethylene oxide (hereinafter abbreviated as “EO”), propylene oxide (hereinafter abbreviated as “PO”), 1,2-, 1,3-, or 2,3-butylene oxide, tetrahydrofuran, α-olefin (C₄ to C₃₀) oxide, epichlorohydrin, styrene oxide and mixture of two or more thereof. Among them, preferred is EO. The mode of the addition is preferably random addition and/or block addition.

The added alkylene oxide may be 1 to 30 moles, preferably 1 to 10 moles, more preferably 1 to 5 moles.

The MW of said (b3) is preferably 300 to 20,000, more preferably 400 to 15,000, even more preferably 500 to 10,000, particularly preferably 1,000 to 4,000, extremely preferably 1,500 to 3,800, most preferably 2,000 to 3,500. The MW is, in the way that a sufficient surface activity can be provided, preferably not less than 300, more preferably not less than 1,000; and in the way that the resulting aqueous resin dispersion can be low in viscosity and stable, preferably not more than 20,000, and in the view of water resistance, more preferably not more than 4,000.

In the above (b3), the weight ratio of the component units, (b1)/(b2)/ the added AO is preferably (1 to 5)/(0 to 99)/(0 to 99)/, more preferably (1 to 5)/(1 to 60)/(1 to 60).

Specific examples of said (b3) include, for example, an EO adduct (1 to 25 moles) of styrenated (mono-to deca-styrenated) phenol, an EO adduct (1 to 25 moles) of styrenated (mono- to deca-styrenated) cumylphenol.

The above (b3) can be formed by any process of adding the above (b1) and the above (b2) without limitation, but a Friedel-Crafts reaction process is preferable.

Any known Friedel-Crafts reaction process can be used, for example, including a process of poly addition of (b1) the monohydric phenol or the monohydric aromatic alcohol with (b2) the vinyl monomer according to need using a known Lewis acid catalyst such as iron chloride and aluminum chloride.

Examples of the organic diisocyanate (b4) include, but not limited to, those described above.

In view of emulsifying power of the surfactant (B), (b5) the diol and/or the diamine having the polyoxyalkylene chain contains polyoxyalkylene units of preferably 20 to 100% by weight, more preferably 50 to 100% by weight, particularly preferably 70 to 100% by weight based on the weight of the (b5).

Examples of the above (b5) include: (b5-1) a hydroxyl group-terminated polyether diol; (b5-2) a hydroxyl group-terminated polyester diol; and (b5-3) an amino group-terminated polyether diamine. The diol alone, the diamine alone, or both of the diol and the diamine may be used.

As the above (b5-1), for example, a low molecular weight diol, a compound having a structure of an AO-added dihydric phenol, or a mixture thereof may be used.

Examples of the low molecular weight diol include, but not limited to, ethylene glycol (hereinafter abbreviated as “EG”), diethylene glycol, propylene glycol, dipropylene glycol, 1,4-butanediol (hereinafter abbreviated as “14BG”), 1,3-butanediol, neopentyl glycol, 1,6-hexanediol, a low molecular weight diol having a cyclic group such as those disclosed in Japanese Patent Publication No. 45-1474 (1970), bis (hydroxymethyl) cyclohexane, bis (hydroxyethyl) benzene, and ethylene oxide adducts of bisphenol A and mixture of two or more thereof.

Any dihydric phenol can be used without limitation, including, for example, a dihydric phenol having 6 to 30 carbon atoms. Specific examples of the dihydric phenol include: monocyclic dihydric phenol such as catechol, resorcinol and hydroquinone; dihydric condensed ring compound such as dihydroxynaphthalene; bisphenol such as bisphenol A, bisphenol F, bisphenol S, dihydroxydiphenyl ether and dihydroxydiphenyl thioether; binaphthol; and alkyl (C₁ to C₁₀) or halogen (such as chlorine and bromine) substituted compounds thereof such as brominated bisphenol A.

Examples of the above (b5-2) include a condensed polyester diol having the polyoxyethylene units in the above-described manner, which is obtained by a reaction of said (b5-1) having MW of not more than 1,000 with a dicarboxylic acid and/or a low molecular weight diol.

Examples of the low molecular weight diol include those described above.

Examples of the dicarboxylic acid include: an aliphatic dicarboxylic acid such as succinic acid, adipic acid, azelaic acid, and sebacic acid; an aromatic dicarboxylic acid such as terephthalic acid, isophthalic acid, and phthalic acid; an ester formable derivative of these dicarboxylic acids such as an acid anhydride and a lower alkyl (C₁ to C₄) ester; and mixture of two or more thereof.

As the above (b5-3), the product obtained with the above (b5-1) by the modification of the terminal hydroxyl group therein into an amino group may be used.

Any known method can be used to modify the terminal hydroxyl group into the amino group, including, for example, a method of reducing a terminal cyanoalkyl group obtained by a cyanoalkylation of the terminal hydroxyl group of the (b5-1) to an aminoalkyl group (e.g., the (b5-1) having the terminal hydroxyl group is allowed to react with acrylonitrile or nonenenitrile, and the resultant cyanoethyl compound is hydrogenated).

Among them, preferred is a method of reducing a terminal cyanoalkyl group obtained by a cyanoalkylation of the terminal hydroxyl group of the (b5-1) to an aminoalkyl group.

Usually, the MW of said (b5) is preferably 200 to 10,000 or more, more preferably 600 to 6,000, still more preferably 1,000 to 4,000, particularly preferably 1,500 to 3,800, extremely preferably 2.000 to 3,500. The MW is, in the way that a sufficient surface activity can be provided, preferably not less than 200, and in view of the water resistance, preferably not more than 10,000.

As the (b6), those described above as the blocking agent for the isocyanate group may be used.

As the polyepoxy compound (b7), those described above as the polyepoxy compound may be used.

As a component of the reactive surfactant (B1), a chain-lengthening agent (b8) may optionally be contained. Examples of the (b8) include water; the above-described low molecular weight diol; diamine such as an aliphatic diamine having 2 to 6 carbon atoms (e.g., ethylene diamine and 1,2-propylene diamine), an alicyclic diamine having 6 to 15 carbon atoms (e.g., isophorone diamine and 4,4′-diaminodicyclohexylmethane) and an aromatic diamine having 6 to 15 carbon atoms (e.g., 4,4′-diaminodiphenylmethane); monoalkanolamine such as monoethanolamine; hydrazine or its derivatives such as dihydrazide adipate; and mixture of two or more thereof. Among them, preferred is the low molecular weight diols, and particularly preferred are EG and 14BG.

Preferably, the reactive surfactant (B) of the present invention is a compound (B2) comprising: (b3′) an alkylene oxide adduct of an addition reaction product of (b1) amonohydricphenol or a monohydric aromatic alcohol and (b2) a vinyl monomer according to need; and (b6) a blocking agent or (b7) a polyepoxy compound, as main components, in which said (b3′) contains an oxyethylene group, and is added with at least one group selected from the group consisting of an isocyanate group, a blocked isocyanate group and an epoxy group. Alkylene oxides in the (b1), (b2), (b6), (b7) and (b3′) are same as in the above (B1).

The reactive surfactant (B2) comprises one or two or more of compounds represented by the general formulae (3) or (4);

Q′—CONH—G—NHCO—Y (3)

Q′—Z (4)

Wherein, Q′ represents a residue of (b3′) an alkylene oxide adduct of an addition reaction product of (b1) a monohydric phenol or a monohydric aromatic alcohol and (b2) a vinyl monomer according to need; G represents a residue of (b4) an organic diisocyanate; Y represents a residue of (b6) a blocking agent; and Z represents a residue of (b7) a polyepoxy compound.

The MW of the surfactant (B2) is preferably 1,500 to 30,000, more preferably 2,000 to 20,000, particularly preferably 3,000 to 15,000. The MW is, in the way that a sufficient surface activity can be provided, preferably not less than 1,500; and in the way that the resulting aqueous resin dispersion can be low in viscosity and stable, preferably not more than 30,000. The MW can be measured by gel permeation chromatography (GPC).

The MW of said (b3′) is preferably 100 to 19,000, more preferably 200 to 14,000, still more preferably 300 to 9,000, particularly preferably 1,000 to 4,000, extremely preferably 1,500 to 3,800, most preferably 2,000 to 3,500. The MW is, in the way that a sufficient surface activity can be provided, preferably not less than 100, more preferably not less than 1,000; and in the way that the resulting aqueous resin dispersion can be low in viscosity and stable, preferably not more than 19,000, and in view of water resistance, more preferably not more than 4,000.

In the above (b3′), a weight ratio of the component units, (b1)/(b2)/ the added AO is preferably (1 to 5)/(0 to 99)/(0 to 99)/, more preferably (1 to 5)/(1 to 60)/(1 to 60).

Specific examples of said (b3′) include, among those compounds described for the (b3), polyoxyalkylene ether.

As a component of the reactive surfactant (B2), the chain-lengthening agent (b8) described above may optionally be contained.

The reactive surfactant (B0) of the present invention is preferably a compound (B3), which comprises: (b3″) an alkylene oxide adduct of an addition reaction product of (b1) a monohydric phenol or a monohydric aromatic alcohol and (b2) a vinyl monomer according to need; (b4) an organic diisocyanate; and, (b5′) a diol and/or a diamine having a polyoxyalkylene chain, as main components, and which preferably has an amino group, a hydroxyl group or a carboxyl group on the terminal end thereof. More preferably, (B0) is a compound (B3′) having an amino group or a hydroxyl group on the terminal end thereof.

Alkylene oxides in the above (b1) and (b3″) are same as in the above surfactant (B1).

The reactive surfactant (B3′) comprises one or two or more of compounds represented by the general formulae (5) or (6);

Q—(—CONH—G—NHCO—J—)ₘ—OH (5)

Q—(—CONH—G—NHCO—J—)ₘ—NH₂ (6)

Wherein, Q, G and J are same as above. A plurality of G and a plurality of J may be same or different each other, respectively. m is 1 to 20.

The MW of the surfactant (B3) is preferably 1,500 to 30,000, more preferably 2,000 to 20,000, particularly preferably 3,000 to 15,000. The MW is, in the way that a sufficient surface activity can be provided, preferably not less than 1,500; and in the way that the resulting aqueous resin dispersion can be low in viscosity and stable, preferably not more than 30,000. The MW can be measured by gel permeation chromatography (GPC).

The MW of said (b3″) is preferably 1,000 to 4,000, more preferably 1,500 to 3,800, particularly preferably 2,000 to 3,500. The MW is, in the way that a sufficient surface activity can be provided, preferably not less than 1,000; and in view of the water resistance, preferably not more than 4,000.

In the above (b3″), a weight ratio of the component units, (b1)/(b2)/ the added AO is preferably (1 to 5)/(0 to 99)/(0 to 99)/, more preferably (1 to 5)/(1 to 60)/(1 to 60).

Specific examples of the above (b3″) include, among those compounds described for the (b3), polyoxyalkylene ether.

Examples of the organic diisocyanate (b4) include, but not limited to, those described above.

In view of emulsifying power of the surfactant (B0), (b5′) the diol and/or the diamine having the polyoxyalkylene chain contains polyoxyalkylene units of preferably 20 to 100% by weight, more preferably 50 to 100% by weight, particularly preferably 70 to 100% by weight based on the weight of the (b5′).

Examples of the above (b5′) include, among those compounds described for the (b5), a hydroxyl group-terminated polyoxyalkylene ether and an amino group-terminated polyoxyalkylene ether.

The MW of said (b5′) is preferably 1,000 to 4,000, more preferably 1,500 to 3,800, particularly preferably 2,000 to 3,500. The MW is, in the way that a sufficient surface activity can be provided, preferably not less than 1,000; and in the view of the water resistance, preferably not more than 4,000.

As a component of the reactive surfactant (B3), the chain-lengthening agent (b8) described above may optionally be contained.

In the present invention, the reactive surfactant (B1) can be prepared by:

(1) in the case of having a blocked isocyanate group on the end thereof, a conventional process for synthesizing polyurethane resins (one-shot process or multi-stage process) of urethanating (b3) to (b5), and (b6) to prepare polyurethane resin having NCO group on one end thereof, and finally blocking the terminal isocyanate group with a blocking agent. The reaction temperature is usually 30 to 200° C., preferably 50 to 180° C. The reaction time is usually 0.1 to 30 hours, preferably 0.1 to 8 hours.

The reaction is preferably carried out in a solvent-free system or in an organic solvent inactive to the isocyanate. Examples of the organic solvent include acetone, tetrahydrofuran, dimethylformamide, dimethyl sulfoxide, toluene and dioxane. After the generation of the surfactant (B), the organic solvent is preferably removed by distillation and the like; or

(2) in the case of having a terminal epoxy group, a conventional process for synthesizing polyurethane resins (such as one-shot process or multi-stage process) of urethanating (b3) to (b5), and (b6) to prepare polyurethane resins having an active hydrogen on one end thereof, and finally reacting with a polyepoxy compound. The reaction time and the reaction temperature may be same as those above.

The solvent used may also be same as those above.

In the present invention, the reactive surfactant (B2) can be prepared by:

(1) in the case of having a blocked isocyanate group on the end thereof, a conventional process for synthesizing polyurethane resins (one-shot process or multi-stage process) of urethanating (b3′), (b4) and (b6) to prepare resins having NCO group on one end thereof, and finally blocking the terminal isocyanate group with a blocking agent. The reaction time and the reaction temperature may be same as those above.

The solvent used may also be same as those above; or

(2) in the case of having a terminal epoxy group, a process of reacting with (b3′) and (b7). The reaction time and the reaction temperature may be same as those above.

The reaction is preferably carried out in a solvent-free system or in an organic solvent. Same organic solvent as described above may be used. After the generation of the surfactant (B), the organic solvent is preferably removed by distillation and the like.

In the urethanating reaction, an equivalent ratio of hydroxyl group (OH) and amino group (NH₂) to the isocyanate group (NCO) of said (b4), [(OH+NH₂):NCO], is preferably 1: (0.8 to 1.5), more preferably 1:(0.8 to 1.3). When the equivalent ratio of the NCO group is from 0.8 to 1.5, the resulting polyurethane resin can have a moderate molecular weight, and the resulting aqueous resin dispersion can provide a film having good water resistance.

In the present invention, the reactive surfactant (B3) can be prepared by:

(1) a conventional process for synthesizing polyurethane resins (one-shot process or multi-stage process) of urethanating (b3″), (b4), and (b5′) to prepare resins having a hydroxyl group or an amino group on one end thereof. The reaction time and the reaction temperature may be same as those above. The solvent used may also be same as those above. If necessary, a carboxyl group may further be introduced by a process of reacting the terminal hydroxyl group or the terminal amino group with an acid anhydride (such as succinic anhydride, acetic anhydride, phthalic anhydride and maleic anhydride) and the like.

In the above urethanating reaction, an equivalent ratio of the hydroxyl group (OH) and the amino group (NH₂) to the isocyanate group (NCO) of said (b4), [(OH+NH₂):NCO], is preferably 1:(0.6 to 0.95), more preferably 1:(0.7 to 0.9). When the equivalent ratio of the NCO group is from 0.6 to 0.95, the resulting polyurethane resin can have a moderate molecular weight, and the resulting aqueous resin dispersion can provide a film having good water resistance.

In the slurry coating of the present invention, the particulate (A) comprises an active hydrogen-containing resin (a1) and optionally a curing agent (a2). Said (a1) and (a2) are, for example, mixed with each other by dissolving them in an organic solvent or melting and kneading them.

In the slurry coating of the present invention, the particulate (A) may be of indefinite shape or of spherical shape, but preferably of spherical shape in terms of smoothness and evenness of the film. The term “spherical shape” herein refers to the particle shape having a major axis/minor axis ratio in the range of 1.0 to 1.5.

Further, the particulate (A) has the volume average particle diameter of, in view of an amount added of dispersing agent and a water resistance, preferably not less than 0.5 mn, more preferably not less than 0.8 μm, most preferably not less than 1.0 μm; and in view of smoothness of the film derived from melting particulates, preferably not more than 50 μm, more preferably not more than 20 μm, most preferably not more than 10 μm. The particle diameter may be determined by an electron microscopy, a sedimentation method, an electrozone method, a dynamic light-scattering method and the like. The dynamic light-scattering method is preferred because it can provide a suitable range for the particle size measurement.

In the slurry coating of the present invention, aqueous medium is water or mixed solvent of water and water-miscible solvent. Examples of the water-miscible solvent include alcohol solvent and ketone solvent. Specific examples include: alcohol solvent such as methanol, isopropanol, ethanol and n-propanol; and ketone solvent such as acetone and methylethylketone. The mixing ratio of water to the water-miscible solvent is preferably 100/0 to 100/20, more preferably 100/0 to 100/5.

In the slurry coating of the present invention, examples of the organic solvent for dissolving the optional curing agent (a2) in the active hydrogen-containing resin (a1) include aromatic hydrocarbon solvent, aliphatic or alicyclic hydrocarbon solvent, halide solvent, ester or ester ether solvent, ether solvent, ketone solvent, alcohol solvent, amide solvent, sulfoxide solvent, heterocyclic compound solvent and mixture solvent of two or more of them. Among them, preferred are ketone solvent and ether solvent.

Examples of the aromatic hydrocarbon solvent include toluene, xylene, ethylbenzene, tetralin and the like.

Examples of the aliphatic or alicyclic hydrocarbon solvent include n-hexane, n-heptane, mineral spirit, cyclohexane and the like.

Examples of the halide solvent include methyl chloride, methyl bromide, methyl iodide, methylene dichloride, carbon tetrachloride, trichloroethylene, perchloroethylene and the like.

Examples of the ester or ester ether solvent include ethyl acetate, butyl acetate, methoxybutyl acetate, methyl cellosolve acetate, ethyl cellosolve acetate and the like.

Examples of the ether solvent include diethyl ether, tetrahydrofuran, dioxane, ethyl cellosolve, butyl cellosolve, propylene glycol monomethyl ether and the like.

Examples of the ketone solvent include acetone, methyl ethyl ketone, methyl isobutyl ketone, di-n-butyl ketone, cyclohexanone and the like.

Examples of the alcohol solvent include methanol, ethanol, n-propanol, isopropanol, n-butanol, isobutanol, t-butanol, 2-ethylhexyl alcohol, benzyl alcohol and the like.

Examples of the amide solvent include dimethylformamide, dimethylacetamide and the like.

Examples of the sulfoxide solvent include dimethyl sulfoxide and the like.

Examples of the heterocyclic compound solvent include N-methylpyrrolidone and the like.

In the present invention, examples of the resin (a1) having an active hydrogen such as that of an alcoholic hydroxyl group, a phenolic hydroxyl group, an amino group, a carboxylic acid group, a phosphoric acid group and a thiol group include (a1-1) anacrylicresin, (a1-2) apolyesterresin, (a1-3) apolyurethane resin, and (a1-4) an epoxy resin, provided that such resins have the active hydrogen.

Among them, preferred is (a1-1) an acrylic resin.

An equivalent of the active hydrogen in the resin (a1) is preferably 100 to 10,000, more preferably 100 to 5,000, particularly preferably 100 to 2,000.

Examples of a monomer for forming the acrylic resin (a1-1) include: (a1-1-1) acrylic acid, acrylic acid ester without hydroxyl group, acrylamide, acrylonitrile, methacrylic acid, methacrylic acid ester without hydroxyl group and the like; (a1-1-2) acrylate ester having hydroxyl group and methacrylate ester having hydroxyl group; and (a1-1-3) any other optional monomer.

A weight ratio of said (a1-1-1)/(a1-1-2)/(a1-1-3) in the acrylic resin (a1-1) is preferably (0 to 80)/(1 to 100)/(0 to 50), more preferably (1 to 50)/(1 to 50)/(0 to 20).

The a1-1) is prepared by a known polymerization method such as solution polymerization, bulk polymerization and suspension polymerization, and its weight average molecular weight is preferably 1,000 to 200,000, more preferably 2,000 to 50,000, still more preferably 3,000 to 20,000.

Examples of said a1-1-1) include (cyclo)alkyl (meth)acrylate such as methyl (meth)acrylate, ethyl (meth)acrylate, butyl (meth)acrylate, stearyl (meth)acrylate, ethylene glycol di(meth)acrylate, 1,4-butanediol di(meth)acrylate and cyclohexyl (meth)acrylate.

Among them, preferred are methyl (meth)acrylate and n-butyl (meth)acrylate.

Examples of said a1-1-2) include hydroxyalkyl(C₂ to C₄) (meth)acrylate such as 2-hydroxyethyl (meth)acrylate, 2-hydroxypropyl (meth)acrylate and 4-hydroxybutyl (meth)acrylate.

Among them, preferred is 2-hydroxyethyl (meth)acrylate.

Examples of said a1-1-3) include styrene, isobornyl (meth)acrylate and the like, and styrene is preferred.

Examples of the polyester resin a1-2) include a condensed polyester polyol obtained by a reaction of a low molecular weight polyol and/or a polyalkylene ether diol having a molecular weight of not more than 1,000 with a polycarboxylic acid; a polylactone diol obtained by a lactone ring-opening polymerization; and a polycarbonate diol obtained by a reaction of a low molecular weight diol with a carbonate diester of a lower alcohol such as methanol.

Examples of the low molecular weight polyol include the low molecular weight diol described for the above (b5-1) and the like.

Examples of the polyalkylene ether diol having a molecular weight of not more than 1,000 include polytetramethylene ether glycol, polypropylene glycol, polyethylene glycol and mixture of two or more of them.

Examples of the polycarboxylic acid include the dicarboxylic acid described for the above (b5-2) and the like.

Examples of the lactone include ε-caprolactone, γ-butyrolactone, γ-valerolactone and mixture of two or more of them.

The polyester can be produced by any conventional method such as a method of reacting (condensing) the low molecular weight polyol and/or the polyether polyol having a molecular weight of not more than 1,000 with the polycarboxylic acid, or its ester formable derivative (e.g., an anhydride such as maleic anhydride and phthalic anhydride, a lower ester such as dimethyl adipate and dimethyl terephthalate, or halide), or its anhydride and an alkylene oxide such as ethylene oxide and/or propylene oxide, in which the active hydrogen group is allowed to remain by using excess of one component, i.e. the polyol, or a method of adding the lactone to an initiator (the low molecular weight diol and/or the polyether diol having a molecular weight of not more than 1,000).

Examples of the a1-2) include polyethylene adipate diol, polybutylene adipate diol, polyhexamethylene adipate diol, polyneopentyl adipate diol, polyethylenepropylene adipate diol, polyethylenebutylene adipate diol, polybutylenehexamethylene adipate diol, polydiethylene adipate diol, poly(polytetramethylene ether) adipate diol, polyethylene azelate diol, polyethylene sebacate diol, polybutylene azelate diol, polybutylene sebacate diol, polycaprolactone diol or triol, polyhexamethylene carbonate diol and the like.

A component ratio of the polyol to the polycarboxylic acid in the hydroxyl group-containing polyester is, which is represented by a molar ratio [OH]/[COOH] of the hydroxyl group [OH] to the carboxylic group [COOH], preferably 2/1 to 1/1, more preferably 1.5/1 to 1/1, still more preferably 1.3/1 to 1.02/1. A ratio of the other components may be in the same range, simply differing such components from the above. The MW is preferably 1,000 to 50,000, more preferably 2,000 to 20,000, still more preferably 3,000 to 15,000.

Examples of the polyurethane resin a1-3) include a polyaddition product of polyol and diisocyanate.

Specific examples of the diisocyanate include those described above. Specific examples of the polyol include a compound having a structure in which an alkylene oxide (hereinafter abbreviated as AO) is added to an active hydrogen atom-containing polyfunctional compound and mixture of two or more of them.

Examples of the active hydrogen atom-containing polyfunctional compound include: (a1-3-1) polyhydric alcohol; (a1-3-2) polyhydric phenols; (a1-3-3) amines; (a1-3-4) polycarboxylic acids; (a1-3-5) phosphoric acids; (a1-3-6) polythiols; and the like.

Examples of the polyhydric alcohol (a1-3-1) include: dihydric alcohol such as ethylene glycol, propylene glycol, 1,3-butylene glycol, 1,4-butanediol, 1,6-hexanediol, diethylene glycol, neopentyl glycol,

bis(hydroxymethyl)cyclohexane and bis(hydroxyethyl)benzene; trihydric to octahydric polyhydric alcohol such as glycerol, trimethylolpropane, pentaerythritol, diglycerol, α-methylglucoside, sorbitol, xylitol, mannitol, dipentaerythritol, glucose, fructose and sucrose.

Examples of the polyhydric phenols (a1-3-2) include: polyhydric phenol such as pyrogallol, catechol and hydroquinone; and bisphenol such as bisphenol A, bisphenol F and bisphenol S.

Examples of the amines (a1-3-3) include: monoamine such as ammonia, alkyl amine having 1 to 20 carbon atoms (e.g., butyl amine) and aniline; aliphaticpolyamine such as ethylenediamine, trimethylenediamine, hexamethylenediamine and diethylenetriamine; heterocyclic polyamine such as piperazine, N-aminoethylpiperazine and heterocyclic polyamines disclosed in Japanese Patent Publication No. S55-21044; alicyclic polyamine such as dicyclohexylmethane diamine and isophorone diamine; aromatic polyamine such as phenylenediamine, tolylenediamine, diethyltolylenediamine, xylylenediamine, diphenylmethanediamine, diphenylether diamine and polyphenylmethanepolyamine; alkanol amine such as monoethanolamine, diethanolamine, triethanolamine and triisopropanolamine; and the like.

Examples of the polycarboxylic acids (a1-3-4) include: aliphatic polycarboxylic acid such as succinic acid and adipic acid; aromatic polycarboxylic acid such as phthalic acid, terephthalic acid and trimellitic acid.

Examples of the phosphoric acids (a1-3-5) include phosphoric acid, phosphorous acid and phosphonic acid.

Examples of the polythiol (a1-3-6) include a polyhydric polythiol compound obtained by a reaction of glycidyl group-containing compound with hydrogen sulfide.

Two or more of the above-described active hydrogen atom-containing compounds may be used in combination.

Examples of the AO to be added to the active hydrogen atom-containing compound include ethylene oxide (EO), propylene oxide (PO), 1,2-, 2,3- or 1,3-butylene oxide, tetrahydrofuran (THF), styrene oxide, α-olefin oxide and epichlorohydrin.

A single AO may be used alone, or two or more AOs may be used in combination. In the latter case, the AO may be added by block addition such as tip type, balance type and active secondary type, random addition, or combination thereof such as random addition followed by tipping whereby 0 to 50% by weight, preferably 5 to 40% by weight of the ethylene oxide chain is randomly distributed in the molecule, and 0 to 30% by weight, preferably 5 to 25% by weight of the EO chain is tipped at the terminal end of the molecule. Among these AO, preferred are EO alone, PO alone, THF alone, combination of PO and EO, and combination of PO and/or EO and THF, wherein the combination may be random, block or combination thereof.

The AO can be added to the active hydrogen atom-containing compound by a usual method, which is carried out in a single stage or multi-stage in the absence or presence of a catalyst such as an alkali catalyst, an amine catalyst or an acid catalyst (particularly in a later stage for AO addition) under atmospheric or increased pressure.

An unsaturation degree of the polyol is preferably as low as possible, and usually not more than 0.1 meq/g, preferably not more than 0.05 meq/g, more preferably not more than 0.02 meq/g.

A ratio of the polyol to the isocyanate, which is represented by a molar ratio [OH]/[NCO] of the hydroxyl group [OH] to the isocyanate group [NCO], is preferably not less than 1/2 to less than 1/1, more preferably not less than 1/1.5 to less than 1/1, still more preferably not less than 1/1.3 to less than 1/1.02. A ratio of the other components may be in the same range, simply differing such components from the above. A weight average molecular weight is preferably 1,000 to 50,000, more preferably 2,000 to 20,000, still more preferably 3,000 to 15,000.

Examples of the epoxy resin (a1-4)) include an addition condensation product of (a1-4-1) a polyepoxide and (a1-4-2) a polycarboxylic acid. This addition polymerization generates a hydroxyl group which has an active hydrogen group.

Examples of the polycarboxylic acid (a1-4-2) include those described above. The polyepoxide (a1-4-1) may be any of aliphatic, alicyclic, heterocyclic, or aromatic.

Examples of the aromatic polyepoxide (a1-4-1) include glycidyl ether of polyhydric phenol such as bisphenol F diglycidyl ether, bisphenol A diglycidyl ether, bisphenol B diglycidyl ether, bisphenol AD diglycidyl ether, bisphenol S diglycidyl ether, halogenated bisphenol A diglycidyl, tetrachlorobisphenol A diglycidyl ether, catechin diglycidyl ether, resorcinol diglycidyl ether, hydroquinone diglycidyl ether, pyrogallol triglycidyl ether, 1,5-dihydroxynaphthalene diglycidyl ether, dihydroxybiphenyl diglycidyl ether, octachloro-4,4′-dihydroxybiphenyl diglycidyl ether, glycidyl ether product of phenol or cresol novolac resin, a diglycidyl ether product obtained by a reaction of 2 moles of bisphenol A with 3 moles-of epichlorohydrin, polyphenol polyglycidyl ether product obtained by a condensation reaction of phenol with glyoxal, glutaraldehyde or formaldehyde, and polyphenol polyglycidyl ether product obtained by a condensation reaction of resorcin with acetone.

Further, in the present invention, examples of the aromatic polyepoxide also include a diglycidyl urethane compound obtained by an addition reaction of tolylene diisocyanate or diphenylmethane diisocyanate with glycidol, a glycidyl group-containing polyurethane (pre)polymer obtained by a reaction of the above two reactants with a polyol, and diglycidyl ether product of bisphenol A-alkylene oxide (ethylene oxide or propylene oxide) adducts.

Examples of the heterocyclic polyepoxide (a1-4-1) include tris(glycidyl)melamine.

Examples of the alicyclic polyepoxide (a1-4-1) include vinylcyclohexene dioxide, limonene dioxide, dicyclopentadiene dioxide, bis(2,3-epoxycyclopentyl)ether, ethylene glycol bisepoxydicyclopentyl ether,

3,4-epoxy-6-methylcyclohexylmethyl-3′,4′-epoxy-6′-methylcyc lohexane carboxylate,
bis(3,4-epoxy-6-methylcyclohexylmethyl) adipate and bis(3,4-epoxy-6-methylcyclohexylmethyl)butylamine. The alicyclic compound also includes a nucleus-hydrogenated compound of the above aromatic polyepoxide compound.

Examples of the aliphatic polyepoxide (a1-4-1) include polyglycidyl ether of polyhydric aliphatic alcohol, polyglycidyl ester of polyhydric fatty acid, glycidyl aliphatic amine and the like.

Examples of the polyglycidyl ether of the polyhydric aliphatic alcohol include ethylene glycol diglycidyl ether, propylene glycol diglycidyl ether, tetramethylene glycol diglycidyl ether, polyethylene glycol diglycidyl ether, polypropylene glycol diglycidyl ether, trimethylolpropane triglycidyl ether, pentaerythritol tetraglycidyl ether, sorbitol polyglycidyl ether and the like.

Examples of the polyglycidyl ester of the polyhydric fatty acid include diglycidyl adipate and the like.

Examples of the glycidyl aliphatic amine include N,N,N′,N′-tetraglycidyl hexamethylenediamine and the like.

In the present invention, the aliphatic compound also includes glycidyl (meth)acrylate (co)polymers.

Among them, preferred is a condensation product of bisphenol A diglycidyl ether and adipic acid. The MW is preferably 1,000 to 200,000, more preferably 2,000 to 100,000, still more preferably 3,000 to 20,000.

The curing agent (a2) may be any compound as long as it has not less than two isocyanate groups per molecule, for example, including the above-described organic diisocyanates and the above-described modifications thereof.

Among them, preferred are HDI isocyanurate and IPDI isocyanurate.

Examples of the blocking agent include those blocking agents described above and mixture of two or more of them.

A ratio of the active hydrogen-containing resin (a1) to the curing agent (a2), which is represented by a molar ratio of the active hydrogen group of the resin (a1) to the isocyanate group of the (a2), is preferably not less than 1/1 to less than 2/1, more preferably not less than 1.2/1 to less than 1.8/1, still more preferably not less than 1.3/1 to less than 1.6/1.

The curing agent (a2) may also be added to aqueous medium in which the particulate (A) or a solution of said (A) is dispersed.

Thus, embodiments of the slurry coating of the present invention include: a water-dispersed slurry coating comprising, in aqueous medium, a particulate (A) comprising a resin (a1) having an active hydrogen group and a reactive surfactant (B) consisting of a hydrophilic moiety and a hydrophobic moiety and having at least one group selected from the group consisting of an isocyanate group, a blocked isocyanate group and an epoxy group on the hydrophilic moiety; a water-dispersed slurry coating further comprising a curing agent (a2) in the above water-dispersed slurry coating; a water-dispersed slurry coating comprising, in aqueous medium, a particulate (A) comprising a resin (a1) having an active hydrogen group, a reactive surfactant (B0) consisting of a hydrophilic moiety and a hydrophobic moiety and having at least one group selected from the group consisting of an amino group, a hydroxyl group and a carboxyl group on the hydrophilic moiety, and a curing agent (a2); and the like.

In the slurry coating of the present invention, a content of the reactive surfactant (B) or (B0) is, based on the total weight of the particulate (A) and the reactive surf actant (B) or the total weight of the particulate (A) and the reactive surfactant (B0) respectively, preferably 0.1 to 10% by weight, more preferably 0.5 to 8% by weight, most preferably 1 to 5% by weight.

A content of the resin in the slurry coating of the present invention is preferably 20 to 75% by weight, more preferably 20 to 60% by weight. The resin in the slurry coating has particles with a volume average diameter of 0.5 to 50 μm.

A resin content of 20 to 75% by weight can provide good dispersibility of the particulate (A) in water. A particle diameter of the particulate (A) of 0.5 to 50 μm can prevent the precipitation of the particles in water and facilitate the water vaporization in baking and the viscosity control.

As far as the effects of the present invention are not deteriorated, said (B) or (B0) may be used in combination with a known emulsifier or surfactant (including a nonionic emulsifier and surfactant, or various reactive emulsifiers and surfactants). An amount used of the combined other emulsifier or surfactant is, based on the total weight of the emulsifier or surfactant, preferably not more than 30% by weight, more preferably not more than 10% by weight.

Depending on the desired use, the slurry coating of the present invention may optionally contain any known additive (C) such as a viscosity modifier, a reaction promoter, a filler, a thickener, a heat-or weather-resistance stabilizer, a leveling agent, an antifoamer, a preservative and a coloring agent.

Examples of the viscosity modifier include a polymer-type viscosity modifier such as polyether and an association-type viscosity modifier such as urethane-modified polyether. A content of it is, based on the slurry coating, preferably not less than 0.05% to not more than 10.0%, more preferably not less than 0.1% to not more than 5%.

Examples of the reaction promoter include: amine compound such as diazabicyclooctane and

1,8-diazabicyclo[5,4,0]-undecene-7; and metal-containing compound such as dibutyltin dilaurate and zirconium octylate. A content of it is, based on the slurry coating, preferably not less than 0.05% to not more than 5%, more preferably not less than 0.1% to not more than 3%.

Examples of the weather-resistance stabilizer include: a salicylic acid-type UV absorber such as phenyl salicylate and p-tert-butylphenyl salicylate; a benzophenone-type UV absorber such as 2,4-dihydroxybenzophenone and

2-hydroxy-4-methoxybenzophenone; a benzotriazole-type UV absorber such as 2-(2′-hydroxy-5′-methylphenyl) benzotriazole and 2-(2′-hydroxy-5′-tert-butylphenyl)benzotriazole; a cyanoacrylate-type UV absorber such as
2-ethylhexyl-2-cyano-3,3′-diphenyl acrylate; and a hindered amine light stabilizer such as octylated diphenylamine and isooctyl-3-(3,5-di-tert-butyl-4-hydroxyphenol) propionate. A content of it is, based on the slurry coating, preferably not less than 0.05% to not more than 10%, more preferably not less than 0.5% to not more than 3%.

Examples of the leveling agent include, but are not limited to; olefin resin such as low molecular weight polyethylene and low molecular weight polypropylene; olefin copolymer such as ethylene-acryl copolymer and ethylene-methacryl copolymer; (meth)acryl copolymer; and polyvinyl pyrrolidone. A content of it is, based on the slurry coating, preferably not less than 0.2% to not more than 6%, more preferably not less than 0.5% to not more than 3%.

Examples of the coloring agent used as needed include, but not limited to; an inorganic pigment, an organic pigment and a dye. Examples of the inorganic pigment include titanium oxide, carbon black, chromium oxide and ferrite. Examples of the organic pigment include azo pigments such as azo lake, monoazo type, disazo type, and chelate azo type; and polycyclic pigments such as benzimidazolone type, phthalocyanine type, quinacridone type, dioxazine type, isoindolinone type, thioindigo type, perylene type, quinophthalone type and anthraquinone type. Examples of the dye include nigrosine types and aniline types. A content of it is, varying according to the kind of the coloring agent, based on the slurry coating, preferably not less than 0.5% to not more than 30%, more preferably not less than 1.0% to not more than 10%.

Examples of the method for preparing the slurry coating of the present invention include the following methods, but not limited to:

(1) Desolvation Method: a method of dispersing the resin (a1) and optionally the curing agent (a2) dissolved in the above-described organic solvent into aqueous medium containing the surfactant (B) or (B0) by using a homomixer and the like in a reaction vessel, and if necessary with heating to up to 100° C., reducing a pressure to 0.1 to 15 Torr to desolvate just the water-miscible solvent and the organic solvent while water remaining, and resulting particles with an volume average particle diameter of 0.5 μm to 50 μm dispersed in the water.

(2) Pulverized Particle Dispersion Method: a method of melting and kneading the resin (a1) and optionally said (a2), cooling and pulverizing into resin particles with an volume average particle diameter of 0.5 μm to 50 μm, and dispersing the resin particles into aqueous medium containing the surfactant (B) or (B0) by using a disperser and the like in a reaction vessel.

Among the above, preferred is a method (1).

In the above method (1), a concentration of the (a1) and optional (a2) in the organic solvent is preferably 20 to 75% by weight, more preferably 40 to 60% by weight.

In above methods (1) and (2), a concentration of the (a1) and optional (a2) in the dispersion is preferably 5 to 70% by weight, more preferably 30 to 60% by weight. A system temperature in the aqueous resin dispersion is preferably −5 to 100° C., more preferably 30 to 80° C., and a desolvation time is preferably 0.1 to 50 hours, more preferably 2 to 10 hours.

Examples of the dispersing device used in the above methods of preparing the aqueous resin dispersion include a homomixer, a disperser, a high-pressure homogenizer, a static mixer, a membrane emulsifier, Filmix (trade name) and an ultrasonic wave dispersing machine. Among them, preferred is the homomixer.

In the present invention, the reactive surfactant (B) or (B0) shows good surface activity and good dispersing stability. In addition, by baking after the dispersion is applied, the surfactant is allowed to form a chemical bond to the dispersed material and incorporated into the film so that the film can be excellent in water resistance and strength.

The slurry coating of the present invention can be applied by using a conventional coating equipment for water-based coatings or solvent-based coatings, such as a spray-coating machine, with no need for newly installed equipment.

In a process for forming a film, the film can be formed by applying the slurry coating to an object by spray coating to have a wet film thickness of preferably not less than 10 μm to not more than 200 μm, more preferably not less than 10 μm to not more than 50 μm, and heating this at temperature of preferably not less than 100° C. to not more than 200° C., more preferably not less than 120° C. to not more than 180° C. for a time period of preferably not less than 5 to not more than 60 minutes, more preferably not less than 5 to not more than 30 minutes, still more preferably not less than 5 to not more than 20 minutes.

After the application and baking of the coating of the present invention, the resulting film formed on the object have a thickness of preferably not less than 10 μm to not more than 150 μm, more preferably not less than 15 μm to not more than 50 μm.

The following Examples illustrate the present invention in further detail, but the present invention is not limited to these Examples. Hereinafter, the term “part(s)” mean “part(s) by weight”, and “%” means “% by weight.”

### SYNTHESIS EXAMPLE 1

To a reaction vessel equipped with a stirrer, a dropping funnel, a nitrogen gas introducing tube, a thermometer and a reflux condenser, 53 parts of 4-α-cumylphenol and 23 parts of a Lewis acid catalyst (GalleonEarth, manufactured by Mizusawa Industrial Chemicals, Ltd.) were charged. The inner atmosphere of the reaction system was replaced with nitrogen gas with stirring, and the system was heated to 90° C. At the same temperature, 181 parts of styrene was added dropwise over a time period of 3 hours and reacted at the same temperature for another 5 hours. The reaction mixture was cooled to 30° C., and then the catalyst was filtered to give 220 parts of an adduct of 7 moles of styrene and 1 mole of 4-α-cumylphenol (MW 900) (B0-1). 22.1 parts of an EO-adduct of B0-1 (45% in EO content; MW 1800), 73.7 parts of polyethylene glycol (MW 6,000), 4.1 parts of hexamethylene diisocyanate (hereinafter abbrebiate as “HDI”) and 0.4 parts of methylethylketone oxime (hereinafter abbrebiate as MEK oxime) were reacted at 80° C. for 3 hours to give 100 parts of a reactive surfactant [B-1] with polyoxyethlene chain of MW 5,500, an oxyethylene unit content of 87% by weight, a MW of 30,000, 71 carbons in a hydrocarbon group of a hydrophobic moiety and a blocked isocyanate group of HLB 16.6.

### SYNTHESIS EXAMPLE 2

5.9 parts of a hydroxyl group-containing hydrocarbon obtained by the same Friedel-Crafts reaction as in Example 1 [an EO-adduct of the addition reaction product of 2 moles of styrene and 1 mole of 4-α-cumylphenol (20% in EO content); MW 800], 88.2 parts of polyethylene glycol (MW 4,000), 3.7 parts of HDI and 2.2 parts of bisphenol A diglycidyl ether were reacted at 80° C. for 3 hours to give 100 parts of a reactive surfactant [B-2] with polyoxyethlene chain of MW 5,500, an oxyethylene unit content of 80% by weight, a MW of 30,000, 31 carbons in a hydrocarbon group of a hydrophobic moiety and an epoxy group of HLB 18.0.

### SYNTHESIS EXAMPLE 3

94.4 parts of a hydroxyl group-containing hydrocarbon obtained by the same Friedel-Crafts reaction as in Example 1 [an EO-adduct of the addition reaction product of 7 moles of styrene and 1 mole of 4-α-cumylphenol (80% in EO content); MW 5000], 4.0 parts of IPDI and 1.6 parts of MEK oxime were reacted at 80° C. for 3 hours to give 100 parts of a reactive surfactant [B-3] with polyoxyethlene chain of MW 4,500, an oxyethylene unit content of 31% by weight, a MW of 5,500, 15 carbons in a hydrocarbon group of a hydrophobic moiety and a blocked isocyanate group of HLB 6.2.

### SYNTHESIS EXAMPLE 4

9.5 parts of a hydroxyl group-containing hydrocarbon obtained by the same Friedel-Crafts reaction as in Example 1 [an EO-adduct of the addition reaction product of 7 moles of styrene and 1 mole of phenol (45% in EO content); MW 1700], 84.6 parts of polyethylene glycol (MW 1000), 1.7 parts of HDI and 0.9 parts of MEK oxime were reacted at 80° C. for 3 hours to give 100 parts of a reactive surfactant [B-4] with polyoxyethlene chain of MW 1,000, an oxyethylene unit content of 84% by weight, a MW of 25,000, 62 carbons in a hydrocarbon group of a hydrophobic moiety and a blocked isocyanate group of HLB 16.4.

### SYNTHESIS EXAMPLE 5

16.9 parts of a hydroxyl group-containing hydrocarbon obtained by the same Friedel-Crafts reaction as in Example 1 [an EO-adduct of the addition reaction product of 7 moles of styrene and 1 mole of phenol (45% in EO content); MW 1700], 79.7 parts of polyethylene glycol (MW 4000) and 3.4 parts of HDI were reacted at 80° C. for 3 hours to give 100 parts of a reactive surfactant [B-5] with polyoxyethlene chain of MW 3,600, an oxyethylene unit content of 87% by weight, a MW of 24,000, 62 carbons in a hydrocarbon group of a hydrophobic moiety and a hydroxyl group of HLB 17.2.

### SYNTHESIS EXAMPLE 6

42.2 parts of a hydroxyl group-containing hydrocarbon obtained by the same Friedel-Crafts reaction as in Example 1 [an EO-adduct of the addition reaction product of 7 moles of styrene and 1 mole of phenol (45% in EO content); MW 1700], 50.0 parts of polyethylene glycol (MW 1000) and 8.2 parts of HDI were reacted at 80° C. for 3 hours to give 100 parts of a reactive surfactant [B-6] with polyoxyethlene chain of MW 1,150, an oxyethylene unit content of 72% by weight, a MW of 12,000, 62 carbons in a hydrocarbon group of a hydrophobic moiety and a hydroxyl group of HLB 16.2.

### SYNTHESIS EXAMPLE 7

21.2 parts of a hydroxyl group-containing hydrocarbon obtained by the same Friedel-Crafts reaction as in Example 1 [an EO-adduct of the addition reaction product of 7 moles of styrene and 1 mole of phenol (45% in EO content); MW 1700], 74.7 parts of polyethylene glycol (MW 3000) and 4.1 parts of HDI were reacted at 80° C. for 3 hours to give 100 parts of a reactive surfactant [B-7] with polyoxyethlene chain of MW 2,700, an oxyethylene unit content of 84% by weight, a MW of 18,000, 62 carbons in a hydrocarbon group of a hydrophobic moiety and a hydroxyl group of HLB 16.8.

### COMPARATIVE SYNTHESIS EXAMPLE 1

19.3 parts of polyoxyalkylene monool [an ethylene oxide-adduct of the addition reaction product of 7 moles of styrene and 4-α-cumylphenol; MW 1,500], 77.4 parts of polyethylene glycol (MW 6,000) and 3.3 parts of HDI were reacted at 80° C. for 3 hours until a NCO content was 0% to give 100 parts of a reactive surfactant [B′-8].

### COMPARATIVE SYNTHESIS EXAMPLE 2

To a reaction vessel equipped with a stirrer, a dropping funnel, a nitrogen gas introducing tube, a thermometer and a reflux condenser, 53 parts of 4-α-cumylphenol and 23 parts of a Lewis acid catalyst (GalleonEarth, manufactured by Mizusawa Industrial Chemicals, Ltd.) were charged. The inner atmosphere of the reaction system was replaced with nitrogen gas with stirring, and the system was heated to 90° C. At the same temperature, 410 parts of ethanol-blocked 3-isopropenyl-α,α-dimethylbenzylisocyanate was added dropwise over a time period of 3 hours and reacted at the same temperature for another 5 hours. The reaction mixture was cooled to 30° C., and then the catalyst was filtered to give 220 parts of an adduct of mole of 3-isopropenyl-α,α-dimethylbenzylisocyanate and 1 mole of 4-α-cumylphenol (MW1900) (B0-2). 22.1 parts of an EO-adduct of B0-2 (45% in EO content; MW 3400), 73.7 parts of polyethylene glycol (MW 6,000) and 4.1 parts of HDI were reacted at 80° C. for 3 hours to give 100 parts of a reactive surfactant [B′-9] with polyoxyethlene chain of MW 5,400, an oxyethylene unit content of 86% by weight, a MW of 15,000, 71 carbons in a hydrocarbon group of a hydrophobic moiety and a blocked isocyanate group of HLB 16.2.

### Preparation of Acrylic Hydroxy-Functional Resin

250 parts of xylene was placed in a reaction vessel, heated to 100° C., and then added a mixture of the following proportions dropwise for about 3 hours. During this, the reaction was conducted under nitrogen atmosphere. After the dropwise addition was completed, the reaction was allowed to proceed for 2 hours with keeping the temperature at 100° C.

| | |
|---|---|
| (1) styrene | 23 parts |
| (2) methyl methacrylate | 23 parts |
| (3) butyl acrylate | 20 parts |
| (4) hydroxyethyl acrylate | 33 parts |
| (5) Peroxy D (peroxide manufactured by | 1 part |
| Nippon Oil & Fats Co., Ltd.) | |

After the reaction was completed, the organic solvent and the remaining monomer were removed by vacuum distillation. The reaction product was then dried under vacuum to give an acrylic hydroxy-functional resin (acrylic resin 1) with a hydroxyl group equivalent of 420 and a number average molecular weight of 12,000.

59 parts of the resulting acrylic resin 1 and 41 parts of an MEK oxime-blocked HDI trimer (Sumidur, manufactured by Asahi Kasei Corporation) were kneaded by using a heating kneader at 100° C. and then pulverized into about 5 μm to give an acrylic resin 2 with a volume average particle diameter of 7 μm and a major axis/minor axis ratio of 1.2.

### Preparation of Polyester Resin

200 parts of neopentyl glycol, 93 parts of ethylene glycol and 355 parts of terephthalic acid were placed in a reaction vessel, heated to 230° C., and reacted for 2 hours, while the generated water was removed. Then, 0.2 parts of dibutyltin oxide was added, and the reaction was conducted until the acid value was not more than 0.5 to give a polyester resin (polyester resin 1) having hydroxyl groups at both terminal ends with a number average molecular weight of 7,000, a hydroxyl value of 16.5 mgKOH/g and a hydroxyl equivalent of 926, used for the film of the present invention.

93 parts of the resulting polyester resin 1 and 7 parts of an MEK oxime-blocked HDI trimer (Sumidur, manufactured by Asahi Kasei Corporation) were kneaded by using a heating kneader at 100° C. and then pulverized into about 5 μm to give an polyester resin 2 with a volume average particle diameter of 7 μm and a major axis/minor axis ratio of 1.2.

### Examples of Dispersion Preparation

Into 100 parts of water was dispersed 3 parts of each of the reactive surfactants [B-1] to [B-7] obtained in Synthesis Examples 1 to 7, the surfactant [B′-8] obtained in Comparative Synthesis Example 1, the surfactant [B′-9] obtained in Comparative Synthesis Example 2, a low molecular weight surfactant [B′-10] (an EO adduct of octylphenol, 1,000 in number average molecular weight) and PVA [B′-11] (a partially saponified polyvinyl alcohol, 1,700 in polymerization degree and 88% in saponification degree) to form a dispersion. The resulting products were named “dispersion 1” to “dispersion 10,” respectively.

### EXAMPLE 1

In a beaker, 59 parts of the acrylic resin 1, 41 parts of an MEK oxime-blocked HDI trimer (Sumidur, manufactured by Asahi Kasei Corporation) and 100 parts of tetrahydrofuran were mixed. The mixture was added to 100 parts of the dispersion 1 and mixed by using an Ultra Disperser (manufactured by Yamato Scientific Co., Ltd.) at a revolution speed of 9,000 rpm for 1 minute to have a volume average particle diameter of 5 μm. After mixing, the mixture was charged into a four-neck flask equipped with a stirring rod and a thermometer and then desolvated at ambient temperature for 10 hours under reduced pressure. Then, 0.1 parts of an urethanating catalyst (“TEDA” manufactured by Tosoh Corporation), 0.1 parts of a light-resisting stabilizer (“DIC-TBS” manufactured by Dainippon Ink and Chemicals, Incorporated.) and 3.0 parts of a visco elasticity imparting agent (“SN thickener-651” manufactured by San Nopco Limited.) were added to give a water-dispersed slurry coating. A volume average particle diameter of a dispersed particle was 4.7 μm.

### EXAMPLE 2

A water-dispersed slurry coating was prepared similarly as in Example 1, except that the dispersion 2 was used instead of the dispersion 1, and that a stirring condition of the Ultra Disperser (manufactured by Yamato Scientific Co., Ltd.) was set to a revolution speed of 12,000 rpm for 1 minute. A volume average particle diameter of a dispersed particle was 3.1 μm.

### EXAMPLE 3

A water-dispersed slurry coating was prepared similarly as in Example 1, except that the dispersion 3 was used instead of the dispersion 1, and that a stirring condition of the Ultra Disperser (manufactured by Yamato Scientific Co., Ltd.) was set to a revolution speed of 14,000 rpm for 2 minutes. A volume average particle diameter of a dispersed particle was 2.4 μm.

### EXAMPLE 4

A water-dispersed slurry coating was prepared similarly as in Example 1, except that the dispersion 4 was used instead of the dispersion 1, and that a stirring condition of the Ultra Disperser (manufactured by Yamato Scientific Co., Ltd.) was set to a revolution speed of 16,000 rpm for 2 minutes. A volume average particle diameter of a dispersed particle was 1.8 μm.

### EXAMPLE 5

A water-dispersed slurry coating was prepared similarly as in Example 1, except that the dispersion 5 was used instead of the dispersion 1, and that a stirring condition of the Ultra Disperser (manufactured by Yamato Scientific Co., Ltd.) was set to a revolution speed of 16,000 rpm for 2 minutes. A volume average particle diameter of a dispersed particle was 1.7 μm.

### EXAMPLE 6

A water-dispersed slurry coating was prepared similarly as in Example 1, except that the dispersion 6 was used instead of the dispersion 1, and that a stirring condition of the Ultra Disperser (manufactured by Yamato Scientific Co., Ltd.) was set to a revolution speed of 16,000 rpm for 2 minutes. A volume average particle diameter of a dispersed particle was 1.9 μm.

### EXAMPLE 7

A water-dispersed slurry coating was prepared similarly as in Example 1, except that the dispersion 7 was used instead of the dispersion 1, and that a stirring condition of the Ultra Disperser (manufactured by Yamato Scientific Co., Ltd.) was set to a revolution speed of 16,000 rpm for 2 minutes. A volume average particle diameter of a dispersed particle was 2.3 μm.

### COMPARATIVE EXAMPLE 1 TO 4

Water-dispersed slurry coatings were prepared similarly as in Example 1, except that dispersions 8 to 11 were used instead of the dispersion 1, respectively. Comparative Example 1: a volume average particle diameter of a dispersed particle was 4.8 μm, Comparative Example 2: a volume average particle diameter of a dispersed particle was 5.1 μm, Comparative Example 3: a volume average particle diameter of a dispersed particle was 4.9 μm, Comparative Example 4: a volume average particle diameter of a dispersed particle was 4.8 μm.

### EXAMPLE 8

To 100 parts of the dispersion 1 obtained according to Example of Dispersion Preparation was added 100 parts of the obtained acrylic hydroxy-functional resin fine powder (acrylic resin 2), and mixed by using an Ultra Disperser (manufactured by Yamato Scientific Co., Ltd.) at a revolution speed of 9,000 rpm for 1 minute, and then added 0.1 parts of an urethanating catalyst (“TEDA” manufactured by Tosoh Corporation) and 0.1 parts of a light-resisting stabilizer (“DIC-TBS” manufactured by Dainippon Ink and Chemicals, Incorporated.) to give a desired water-dispersed slurry coating with a volume average particle diameter of a dispersed particle being 7 μm.

### EXAMPLE 9

A water-dispersed slurry coating was prepared similarly as in Example 8, except that the dispersion 2 was used instead of the dispersion 1. A volume average particle diameter of a dispersed particle was 7 μm.

### EXAMPLE 10

A water-dispersed slurry coating was prepared similarly as in Example 8, except that the dispersion 5 was used instead of the dispersion 1. A volume average particle diameter of a dispersed particle was 7 μm.

### COMPARATIVE EXAMPLES 5 TO 8

Water-dispersed slurry coatings were prepared similarly as in Example 8, except that dispersions 8 to 11 were used instead of the dispersion 1, respectively. Comparative Example 5: a volume average particle diameter of a dispersed particle was 7 μm, Comparative Example 6: a volume average particle diameter of a dispersed particle was 7 μm, Comparative Example 7: a volume average particle diameter of a dispersed particle was 7 μm, Comparative Example 8: a volume average particle diameter of a dispersed particle was 7 μm.

### EXAMPLE 11

In a beaker, 93 parts of the polyester resin 1, 7 parts of an MEK oxime-blocked HDI trimer (Sumidur, manufactured by Asahi Kasei Corporation) and 100 parts of tetrahydrofuran were mixed. The mixture was added to 100 parts of the dispersion 1 and mixed by using an Ultra Disperser (manufactured by Yamato Scientific Co., Ltd.) at a revolution speed of 9,000 rpm for 1 minute to have a volume average particle diameter of 5 μm. After mixing, the mixture was charged into a four-neck flask equipped with a stirring rod and a thermometer and then desolvated at ambient temperature for 10 hours under reduced pressure. Then, 0.1 parts of an urethanating catalyst (“TEDA” manufactured by Tosoh Corporation), 0.1 parts of a light-resisting stabilizer (“DIC-TBS” manufactured by Dainippon Ink and Chemicals, Incorporated.) and 3.0 parts of a viscoelasticity imparting agent (“SN thickener-651” manufactured by San Nopco Limited.) were added to give a desired water-dispersed slurry coating with a volume average particle diameter of a dispersed particle being 5.1 μm.

### EXAMPLE 12

A water-dispersed slurry coating was prepared similarly as in Example 11, except that the dispersion 2 was used instead of the dispersion 1. A volume average particle diameter of a dispersed particle was 4.9 μm.

### EXAMPLE 13

A water-dispersed slurry coating was prepared similarly as in Example 11, except that the dispersion 5 was used instead of the dispersion 1. A volume average particle diameter of a dispersed particle was 4.2 μm.

### COMPARATIVE EXAMPLES 9 TO 12

Water-dispersed slurry coatings were prepared similarly as in Example 11, except that dispersions 8 to 11 were used instead of the dispersion 1, respectively. Comparative Example 9: a volume average particle diameter of a dispersed particle was 4.8 μm, Comparative Example 10: a volume average particle diameter of a dispersed particle was 4.9 μm, Comparative Example 11: a volume average particle diameter of a dispersed particle was 5.1 μm, Comparative Example 12: a volume average particle diameter of a dispersed particle was 4.8 μm.

### EXAMPLE 14

To 100 parts of the dispersion 1 obtained according to Example of Dispersion Preparation was added 100 parts of the resulting polyester hydroxy-functional resin fine powder (polyester resin 2), and mixed by using an Ultra Disperser (manufactured by Yamato Scientific Co., Ltd.) at a revolution speed of 9,000 rpm for 1 minute. Then 0.1 parts of an urethanating catalyst (“TEDA” manufactured by Tosoh Corporation) and 0.1 parts of a light-resisting stabilizer (“DIC-TBS” manufactured by Dainippon Ink and Chemicals, Incorporated.) were added to give a desired water-dispersed slurry coating with a volume average particle diameter of a dispersed particle being 7 μm.

### EXAMPLE 15

A water-dispersed slurry coating was prepared similarly as in Example 14, except that the dispersion 2 was used instead of the dispersion 1. A volume average particle diameter of a dispersed particle was 7 μm.

### EXAMPLE 16

A water-dispersed slurry coating was prepared similarly as in Example 14, except that the dispersion 5 was used instead of the dispersion 1. A volume average particle diameter of a dispersed particle was 7 μm.

### COMPARATIVE EXAMPLES 13 TO 16

Water-dispersed slurry coatings were prepared similarly as in Example 14, except that dispersions 8 to 11 were used instead of the dispersion 1, respectively. Comparative Example 13: a volume average particle diameter of a dispersed particle was 7 μm, Comparative Example 14: a volume average particle diameter of a dispersed particle was 7 μm, Comparative Example 15: a volume average particle diameter of a dispersed particle was 7 μm, Comparative Example 16: a volume average particle diameter of a dispersed particle was 7 μm.

Each of the resulting water-dispersed slurry coatings was evaluated by the tests as described below. The results are shown in Tables 1, 2, 3 and 4. In tables, “particle diameter” means a volume average particle diameter of a dispersed particle.

### Preparation of Test Piece

An epoxy resin-based cationic electrode position coating composition was applied (20 μm) to a zinc phosphate-treated cold rolled steel plate of 0.8 mm in thickness and baked at 170° C. for 30 minutes, and then black intermediate coating composition for automobiles was applied (30 μm) and baked at 140° C. for 30 minutes to give a test piece. To the test piece, the resulting water-dispersed slurry coating was applied by spray coating and pre-baked 60° C. for 10 minutes, and then baked at 150° C. for 20 minutes and dried to give a film of approximately 40 μm in thickness.

### Test Methods

<Measurement of Fischer Hardness>: The resulting film was measured for surface hardness with a Fischer hardness tester (FISCHERSCOPE H100V manufactured by Fischer Instrumentation (GB) Ltd.) (load of 0.4 to 100 mN and an indentation depth of 5 μm.).

In this test, hardness of coating films can be quantified with high precision, and several properties on film strength such as indentation hardness and Young's modulus can be evaluated at a time.

Film strength can be evaluated by determining the surface hardness.

<Evaluation for acid rain resistance>: 0.4 g of 30% aqueous solution of sulfuric acid was dropped onto the resulting film, and the film was heated at 80° C. for 30 minutes by using a forced air dryer, rinsed with water, and then the film was observed visually.

◯: There is no change on the film surface.

Δ: Circular marks are seen slightly. ×: Discoloration, whitening or blister is seen noticeably on circular marks.

<Measurement of Solve-Out Rate>: Approximately 10 g of the resulting film was immersed in water at 25° C. for 1 hour, heat-dried at 60° C. for 1 hour by using a forced air dryer, and then weighed. The resulting weight was compared with the film weight before immersion, and the rate of decrease in the film weight was determined as the solve-out rate.

<Evaluation for water resistance>: The resulting film was immersed in water at 40° C. for 10 days, and then the film was observed visually.

◯: There is no change on the film.

Δ: Whitening of the film is seen slightly.

×: Whitening of the film is seen noticeably.

TABLE 1

| | | Particle | | Fischer | | | |
|---|---|---|---|---|---|---|---|
| | | Diameter | Major Axis/ | Hardness | Acid Rain | Solve-Out | Water |
| | Surfactant | [μm] | Minor Axis | [N/mm2] | Resistance | Rate (%) | Resistance |
| Example 1 | B-1 | 4.7 | 1.0 | 137 | ◯ | 0 | ◯ |
| Example 2 | B-2 | 3.1 | 1.0 | 140 | ◯ | 0 | ◯ |
| Example 3 | B-3 | 2.4 | 1.0 | 142 | ◯ | 0 | ◯ |
| Example 4 | B-4 | 1.8 | 1.0 | 145 | ◯ | 0 | ◯ |
| Example 5 | B-5 | 1.7 | 1.0 | 147 | ◯ | 0 | ◯ |
| Example 6 | B-6 | 1.9 | 1.0 | 136 | ◯ | 0 | ◯ |
| Example 7 | B-7 | 2.3 | 1.0 | 141 | ◯ | 0 | ◯ |
| Comparative | B′-8 | 4.8 | 1.0 | 97 | X | 1 | Δ |
| Example 1 | | | | | | | |
| Comparative | B′-9 | 5.1 | 1.0 | 99 | ◯ | 1 | X |
| Example 2 | | | | | | | |
| Comparative | B′-10 | 4.9 | 1.0 | 101 | X | 3 | X |
| Example 3 | | | | | | | |
| Comparative | B′-11 | 4.8 | 1.0 | 97 | X | 3 | X |
| Example 4 | | | | | | | |

TABLE 2

| | | Particle | | Fischer | | | |
|---|---|---|---|---|---|---|---|
| | | Diameter | Major Axis/ | Hardness | Acid Rain | Solve-Out | Water |
| | Surfactant | [μm] | Minor Axis | [N/mm2] | Resistance | Rate (%) | Resistance |
| Example 8 | B-1 | 7.0 | 1.2 | 137 | ◯ | 0 | ◯ |
| Example 9 | B-2 | 7.0 | 1.2 | 137 | ◯ | 0 | ◯ |
| Example 10 | B-5 | 7.0 | 1.2 | 138 | ◯ | 0 | ◯ |
| Comparative | B′-8 | 7.0 | 1.2 | 143 | X | 1 | Δ |
| Example 5 | | | | | | | |
| Comparative | B′-9 | 7.0 | 1.2 | 140 | ◯ | 1 | X |
| Example 6 | | | | | | | |
| Comparative | B′-10 | 7.0 | 1.2 | 99 | X | 3 | X |
| Example 7 | | | | | | | |
| Comparative | B′-11 | 7.0 | 1.2 | 97 | X | 3 | X |
| Example 8 | | | | | | | |

TABLE 3

| | | Particle | | Fischer | | | |
|---|---|---|---|---|---|---|---|
| | | Diameter | Major Axis/ | Hardness | Acid Rain | Solve-Out | Water |
| | Surfactant | [μm] | Minor Axis | [N/mm2] | Resistance | Rate (%) | Resistance |
| Example 11 | B-1 | 5.1 | 1.0 | 137 | ◯ | 0 | ◯ |
| Example 12 | B-2 | 4.9 | 1.0 | 140 | ◯ | 0 | ◯ |
| Example 13 | B-5 | 4.2 | 1.0 | 140 | ◯ | 0 | ◯ |
| Comparative | B′-8 | 4.8 | 1.0 | 138 | X | 1 | Δ |
| Example 9 | | | | | | | |
| Comparative | B′-9 | 4.9 | 1.0 | 138 | ◯ | 1 | X |
| Example 10 | | | | | | | |
| Comparative | B′-10 | 5.1 | 1.0 | 101 | X | 2 | X |
| Example 11 | | | | | | | |
| Comparative | B′-11 | 4.8 | 1.0 | 96 | X | 3 | X |
| Example 12 | | | | | | | |

TABLE 4

| | | Particle | | Fischer | | | |
|---|---|---|---|---|---|---|---|
| | | Diameter | Major Axis/ | Hardness | Acid Rain | Solve-Out | Water |
| | Surfactant | [μm] | Minor Axis | [N/mm2] | Resistance | Rate (%) | Resistance |
| Example 14 | B-1 | 7.0 | 1.2 | 137 | ◯ | 0 | ◯ |
| Example 15 | B-2 | 7.0 | 1.2 | 145 | ◯ | 0 | ◯ |
| Example 16 | B-5 | 7.0 | 1.2 | 141 | ◯ | 0 | ◯ |
| Comparative | B′-8 | 7.0 | 1.2 | 143 | X | 1 | Δ |
| Example 13 | | | | | | | |
| Comparative | B′-9 | 7.0 | 1.2 | 140 | ◯ | 1 | X |
| Example 14 | | | | | | | |
| Comparative | B′-10 | 7.0 | 1.2 | 101 | X | 3 | X |
| Example 15 | | | | | | | |
| Comparative | B′-11 | 7.0 | 1.2 | 97 | X | 3 | X |
| Example 16 | | | | | | | |

### INDUSTRIAL APPLICABILITY

The water-dispersed slurry coating of the present invention can be used for, particularly a top coating for automobiles, as well as a variety of manufactured articles such as architectural structures and home electric appliances.

1. A water-dispersed slurry coating, comprising: (A) particulates comprising (a1) a resin having a group containing an active hydrogen; and (B) a reactive surfactant comprising a hydrophilic moiety and a hydrophobic moiety and having at least one group selected from the group consisting of an isocyanate group, a blocked isocyanate group and an epoxy group in the hydrophilic moiety, in aqueous medium.

2. The water-dispersed slurry coating according to claim 1, further comprising (a2) a curing agent.

3. A water-dispersed slurry coating, comprising: (A) particulates comprising (a1) a resin having a group containing an active hydrogen; (B0) a reactive surfactant comprising a hydrophilic moiety and a hydrophobic moiety and having at least one group selected from the group consisting of an amino group, a hydroxyl group and a carboxyl group in the hydrophilic moiety; and (a2) a curing agent, in aqueous medium.

4. The water-dispersed slurry coating according to claims 1, wherein the reactive surfactant (B) comprises a hydrophobic moiety having an aromatic ring-containing hydrocarbon group having 6 to 100 carbon atoms.

5. The water-dispersed slurry coating according to claims 1, wherein the reactive surfactant (B) has an oxyethylene group in a content of not less than 20% and not more than 97% by weight based on a weight of (B).

6. The water-dispersed slurry coating according to claims 1, wherein the reactive surfactant (B) comprises a hydrophilic moiety having a polyoxyethylene chain of a weight average molecular weight of not less than 1,000 and not more than 4,000, and a weight average molecular weight of the reactive surfactant (B) is not less than 1,500 and not more than 30,000.

7. The water-dispersed slurry coating according to claim 1, wherein the reactive surfactant (B) is a urethane resin comprising: (b3) an addition reaction product of (b1) a monohydric phenol or a monohydric aromatic alcohol and (b2) a vinyl monomer according to need, or an alkylene oxide adduct of the addition reaction product; (b4) an organic diisocyanate; (b5) a diol and/or a diamine having a polyoxyalkylene chain; and (b6) a blocking agent or (b7) a polyepoxy compound, as main components, wherein said (b3) and/or said (b5) comprises an oxyethylene group, and an isocyanate group which may be blocked or an epoxy group is added to said (b3) and/or said (b5).

8. The water-dispersed slurry coating according to claim 7, wherein the reactive surfactant (B) comprises one or more of compounds represented by the general formulae (1) or (2);
Q—(—CONH—G—NHCO—J—)ₘ—CONH—G—NHCO—Y (1)
Q—(—CONH—G—NHCO—J—)ₘ—Z (2)
wherein, Q represents a residue of (b3) an addition reaction product of (b1) a monohydric phenol or a monohydric aromatic alcohol and (b2) a vinyl monomer according to need, or an alkylene oxide adduct of the addition reaction product; G represents a residue of (b4) an organic diisocyanate; J represents a residue of (b5) a diol and/or a diamine having a polyoxyalkylene chain; Y represents a residue of (b6) a blocking agent; and Z represents a residue of (b7) a polyepoxy compound; wherein a plurality of G and a plurality of J may be same or different each other, respectively; and m is 1 to 20.

9. The water-dispersed slurry coating according to claim 1, wherein the reactive surfactant (B) is a compound comprising: (b3′) an alkylene oxide adduct of an addition reaction product of (b1) a monohydric phenol or a monohydric aromatic alcohol and (b2) a vinyl monomer according to need; and (b6) a blocking agent or (b7) a polyepoxy compound, as main components, wherein said (b3′) comprises an oxyethylene group, and an isocyanate group which may be blocked or an epoxy group is added to said (b3′).

10. The water-dispersed slurry coating according to claim 9, wherein the reactive surfactant (B) comprises one or more of compounds represented by the general formulae (3) or (4);
Q′—CONH—G—NHCO—Y (3)
Q′—Z (4)
wherein, Q′ represents a residue of (b3′) an alkylene oxide adduct of an addition reaction product of (b1) a monohydric phenol or a monohydric aromatic alcohol and (b2) a vinyl monomer according to need; G represents a residue of (b4) an organic diisocyanate; Y represents a residue of (b6) a blocking agent; and Z represents a residue of (b7) a polyepoxy compound.

11. The water-dispersed slurry coating according to claim 3, wherein the reactive surfactant (B0) is a compound comprising: (b3″) an alkylene oxide adduct of an addition reaction product of (b1) a monohydric phenol or a monohydric aromatic alcohol and (b2) a vinyl monomer according to need; (b4) an organic diisocyanate; and, (b5′) a diol and/or a diamine having a polyoxyalkylene chain, as main components, and having an amino group or a hydroxyl group on one of the terminal ends thereof.

12. The water-dispersed slurry coating according to claim 11, wherein the reactive surfactant (B0) comprises one or more of compounds represented by the general formulae (5) or (6);
Q—(—CONH—G—NHCO—J—)ₘ—OH (5)
Q—(—CONH—G—NHCO—J—)ₘ—NH₂ (6)
wherein, Q, G and J are same as above; wherein a plurality of G and a plurality of J may be same or different each other, respectively; and m is 1 to 20.

13-15. (canceled)

16. The water-dispersed slurry coating according to claims 1, wherein the particulate (A) is obtained by dispersing a solvent solution of the resin having a group containing an active hydrogen (a1) in water and desolvating the solvent.

17. A film obtained by applying a water-dispersed slurry coating according to claims 1 and baking the same.

18. The water-dispersed slurry coating according to claim 3, wherein the reactive surfactant (BO) comprises a hydrophobic moiety having an aromatic ring-containing hydrocarbon group having 6 to 100 carbon atoms.

19. The water-dispersed slurry coating according to claim 3, wherein the reactive surfactant (BO) has an oxyethylene group in a content of not less than 20% and not more than 97% by weight based on a weight of (BO).

20. The water-dispersed slurry coating according to claim 3, wherein the reactive surfactant (BO) comprises a hydrophilic moiety having a polyoxyethylene chain of a weight average molecular weight of not less than 1,000 and not more than 4,000, and a weight average molecular weight of the reactive surfactant (BO) is not less than 1,500 and not more than 30,000.

21. The water-dispersed slurry coating according to claim 3, wherein the particulate (A) is obtained by dispersing a solvent solution of the resin having a group containing an active hydrogen (a1) in water and desolvating the solvent.

22. A film obtained by applying a water-dispersed slurry coating according to claim 3 and banking the same.
